(19) United States
(12) Patent Application Publication
(10) Pub. No.: US 2025/0230083 A1
(43) Pub. Date: Jul. 17, 2025

(54) METHOD FOR PRODUCING WATER WITH PREDTERMINED PROPERTIES AND DEVICE FOR IMPLEMENTATION SAME

(71) Applicant: Dmitrii V. Tateosov, Odintsovo (RU)

(72) Inventor: Dmitrii V. Tateosov, Odintsovo (RU)

(21) Appl. No.: 18/730,177

(22) PCT Filed: Oct. 3, 2022
(86) PCT No.: PCT/RU2022/000298

§ 371 Date: Feb. 26, 2025

(30) Foreign Application Priority Data
Apr. 18, 2022 (RU) 2022110401

(51) Int. Cl. C02F 9/00; B01D 61/02; B01D 61/14; B01D 61/16; B01D 61/58; C02F 1/44; C02F 1/461; C02F 1/78

(52) U.S. Cl. CPC C02F 9/00; B01D 61/16; B01D 61/58; B01D 61/025; B01D 61/145; B01D 2311/04; B01D 2317/02; C02F 1/441; C02F 1/444; C02F 1/461; C02F 1/78; C02F 2209/06

(57) ABSTRACT

Invention provides a method of producing water with predetermined properties. The method consists of the steps of performing pretreatment of water, membrane filtration, producing a catholyte and an anolyte in an electrolyser, and mixing the catholyte and anolyte. The step of membrane filtration is performed in membrane filtration apparatuses. Purified water is supplied to the inlet compartment of the first membrane filtration apparatus using a water-jet ejector. An ozone-air or ozone-oxygen mixture is supplied through the ejector to ozonize the water. The catholyte is added to the step of the water pretreatment process until the pH value in the range from 8.0 to 11.0 is reached in the filtered water during the step of pretreatment in the first membrane filtration apparatus.

### FIELD OF THE INVENTION

The invention relates to the field of producing water with specified properties related to the purity and pH value.

### DISCUSSION OF THE PRIOR ART

Currently, there are many methods and devices for water purification, differing in their purpose, which determines related technology and design. Among this multitude, it is possible to identify methods and devices for producing water with specified properties in terms of the degree of purity and pH value. In particular, alkaline water with a pH>8 is in demand in medicine and other scientific fields.

A major problem for obtaining alkaline water, i.e. water with a predetermined pH value, also involves purifying the source water from organic impurities that are present in it.

Organic impurities prevent the effective electrolysis of water to produce water with a predetermined pH value. This is because the impurities clog the pores of the filter membranes, requiring their initial elimination. This is done by oxidation and subsequent filtering of oxidation products of the organic impurities.

Oxidation products of organic impurities, when sufficiently oxidized, practically do not clog membrane pores. However, this is not always possible to achieve using known methods. This raises the problem of cleaning filter membranes from oxidation products of organic contaminants.

It is known from the scientific literature that the oxidation of organic impurities in water occurs more intensely in an alkaline environment. It is likely that this occurs due to the effect on organic compounds of the ozonide ion-03′, which is a strong oxidizing agent and is formed during the decomposition of ozone in an alkaline environment.

This property provides ozone with a high ability to oxidize organic water contaminants in an alkaline environment. However, the data provided in these sources are only of a scientific, fundamental nature and does not allow to achieve practical implementation leading to the regularity of increased oxidizability of organic compounds by ozone in alkaline medium.

Nevertheless, there is a known solution to the problem of decomposition of organic compounds of wastewater by ozone in the cathode space saturated with hydroxyl ions, i.e. in an alkaline environment (see WIPO Application No 2003338167, Publication No 2005103391). The essence of the method is to bubble ozone through wastewater into which DC/direct current electrodes are lowered.

The disadvantages of the method and design are low productivity due to contamination of the electrodes with decomposition products and the complexity of additional placement of such equipment related to the need to increase the technological volume of the apparatus.

A water vending machine is also known, wherein pre-filtration and ultra-fine water filtration devices are used for water purification, an electrolyzer for water treatment, with storage tanks for cationite-alkaline water and anolyte-acidic water, which have water inlet and outlet for consumers, and also a control system including a touch screen control.

A membrane type filter was used as a pre-filtration filter to separate mechanical impurities. For further purification of water before the electrolyzer, a filter with activated carbon and KDF catalytic powder, which is an ultrafine filtration device, is used. KDF is short for kinetic degradation fluxion. This type of media typically consists of granules made from high-purity copper-zinc, which are designed to produce a redox reaction to greatly reduce common water impurities.

The disadvantage of this apparatus is the absence of a device for disinfecting the water entering the apparatus and the impossibility of obtaining and dispensing alkaline water with the specified parameters.

The closest prior art known to the inventor is inventor's own Russian Patent No 2758346 disclosing a method used for water treatment in alkaline water vending machines. The method consists of the process of preliminary water treatment, including disinfection by ozone treatment, membrane filtration of water at ultrafiltration and reverse osmosis devices, production of catholyte and anionite in an electrolyzer, as well as their mixing in the required ratio.

This method is carried out in a device for producing alkaline water, containing a contact tank, an ultrafiltration device, a reverse osmosis device and an electrolyzer.

The disadvantages of this method are the contamination of the membrane surface with oxidation products of organic impurities and, as a result, a decrease in their filtering ability, which leads to the need for additional cleaning measures or restoration of membrane functionality.

### Problem to be Solved and Technical Results Achieved by the Invention

The problem to be solved by the invention is to eliminate the shortcomings of the above-mentioned prior art technical solution and achieve a technical result related to the increasing degree of purification of water from organic impurities at the filtration stage occurring on at least the first membrane of the filtration device, as well as expanding the arsenal of technical means for producing water with the predetermined properties.

### SUMMARY OF THE INVENTION

Achieving the specified technical result in the present invention is achieved through the implementation of a method for producing water with predetermined properties, wherein the method consists of the processes of preliminary water preparation, membrane filtration, catholyte and anionite production as well as their mixing in the required ratio.

At the same time, membrane filtration is carried out on at least one membrane filtration device; the supply of purified water to the inlet compartment of at least the first membrane filtration device is carried out using a water-jet ejector, through which an ozone-air or ozone-oxygen mixture is simultaneously supplied to ozonate this water; simultaneously with the above catholyte is supplied into the technological scheme of the water preliminary preparation process until a certain pH value in the filtered water of the first membrane filtration device is reached in the range between 8.0 and 11.0.

For an unambiguous and more complete understanding of the description of the present invention, clarifications and disclosures of the concepts and terms used above, as well as a description of the method, are provided below.

The purpose of the present invention is a method for producing water with predetermined properties, as well as a device for its production. In this case, the predetermined properties should be understood as a predetermined degree of purification from inorganic and organic impurities, as well as a predetermined value of the hydrogen index.

Such water, and especially alkaline water with pH values>8, can be used for medical purposes, as well as in other areas of the national economy. Since in the present invention the production of alkaline water is carried out using an electrolytic process in the cathode space, this water is also called catholyte.

Thus, the concepts of catholyte and alkaline water in this application are considered to be identical. On the other hand, in the electrolytic process, acidic water or anolyte is obtained in the anode space. Such water can also be used for disinfection.

Different water applications require water with different pH values. This can be easily achieved by mixing catholyte and anolyte in a certain ratio.

For medical purposes, as well as for the effective implementation of electrolysis of water in order to obtain catholyte and anolyte, highly purified water is required. Therefore, the present invention provides for the following processes: preliminary water preparation, membrane filtration of water, production of catholyte and anolyte, as well as their mixing in the required ratio.

The process of preliminary water preparation includes pre-cleaning and disinfection processes. The purpose of pre-treatment is to ensure the efficient operation of subsequent membrane filtration devices by separating and separating coarse mechanical contaminants.

Separation from these contaminants is primarily accomplished by mechanical separation of insoluble solids in sedimentation filters or mechanical cleaning filters. The separation of mechanical impurities prevents the membrane filters from being contaminated by solid particles at subsequent stages of water filtration. Simultaneously with the mechanical separation of contaminants, the disinfection process is mainly carried out.

Disinfection is preferably carried out by treatment with ultraviolet radiation or ozonation, preferably in a contact container, which can also serve as a storage tank or reservoir. To enhance the efficiency of such processing, the process is carried out with simultaneous mixing, mainly by recirculation.

To implement the possibility of regulating the described processes, shut-off and/or control valves are installed at the entrance to the preliminary preparation devices and at the exit from them.

It should be noted here that when disinfecting using these methods, partial oxidation of organic and organochlorine impurities occurs simultaneously in the contact container.

The necessary effective oxidation of organic and organochlorine impurities in a real technological process can be achieved in a multi-stage process. After the pre-treatment process, the water is sent for membrane filtration.

Membrane filtration is carried out in one or multiple filtration devices. This depends on the degree of water contamination and the filtering ability of the filtration devices, including the membranes themselves. Membrane filtration first begins with ultrafiltration on a membrane ultrafiltration device.

At the ultrafiltration stage, typically from 1 to 3 devices are used. In this case, the device can have a different number of membranes with a filtering surface of each up to 2 m². Each device is predominantly a filter with a fine-porous membrane, the pore size of which varies in the range of 0.01-0.1 microns.

From the contact tank, water enters the ultrafiltration device with oxidation products of organic and organochlorine impurities. Since it is difficult to achieve complete oxidation of organic and organochlorine impurities, water is supplied from the contact tank to the ultrafiltration device through a water-jet ejector supplying an ozone-air or ozone-oxygen mixture.

It is known from practice that the use of ejectors for supplying gas-liquid mixtures is more effective in terms of productivity and degree of mixing than other common methods of parallel supply of gas and liquid components or bubbling.

The approximate conditions for filtration at the ultramembranes are as follows: differential pressure 0.05-0.6 MPa, flow rate of the ozone-air mixture through the ejector 8×10⁵-56×10⁵ m³/s (0.3-2 m³/hour), dissolved ozone content in the mixture 0.01-1 g/m³, degree of water purification: from suspended solids 100%; from organic substances 60-90%; from other oxidizable impurities 80-90%.

In some cases, it is possible to provide an ejector with two suction pipes for introducing additional components. For design and technological reasons, water can be introduced into the ultrafiltration device using a group of ejectors. One of the benefits of this is the increased ozonation of water, as well as the rate/speed of filtration.

During filtration, oxidation products of organic and organochlorine impurities may accumulate in the inlet compartment of the ultrafiltration device. These products clog the pores of the ultrafiltration membrane, to interfere with the filtration process.

To avoid this, a liquid supply line from the inlet compartment of the first membrane filter is provided/organized. Possibly other supply lines, into the contact tank can be provided. This is equivalent to organizing a second recycling line into the contact tank. Recycling can be accomplished by partially activating the bypass line.

Recycling can reduce contamination of the surface of the ultrafiltration membrane. To regulate the pressure in the inlet compartment of the filter, a throttle can be installed on the recycling line (the second recycling line—the line for returning the filtered liquid to the contact tank), and a drain can be formed to remove contaminants from the system.

If finer water purification is necessary, after the purification stage on ultrafiltration devices, purification by the reverse osmosis method is used. This step is carried out on membranes with a pore size of 10⁴-10³ microns.

The number of reverse osmosis purification devices/membranes also depends on the degree of water contamination and the filtering capacity of the filtration devices, including the membranes themselves, and ranges from 1 to 3. The device can have a different number of membranes with a filtering surface of each up to 2 m², with a total number of up to 5 membranes. The approximate conditions for filtration on reverse osmosis membranes are as follows: differential pressure 0.4-2.0 MPa, water flow 0.1-9 m³/hour and the degree of water purification is between 98 and 99.8%.

Upon achieving the specified purification characteristics, the water is supplied to the electrolyzer, where it is electrolytically processed. The water in the near-electrode areas is converted into catholyte and anolyte or alkaline and acidic water. Electrolysis is carried out to certain specified values of the hydrogen index—pH. Typically, these are values in the narrow pH ranges, which can be between 0.1 and 0.4 pH.

For example, for the preventive application water with pH values from 9.4 to 9.8 is used. The general range of adjustable pH values is from 8.0 to 11.0. The resulting catholyte and anolyte are the basis for producing water with a predetermined pH value, which can be adjusted by mixing the catholyte and anolyte in certain ratios, as well as by changing the water flows at the entrance to the cathode and the anode spaces of the electrolyzer.

Providing alkaline water with specified pH values in the range from 8.0 to 11.0 is a difficult task due to the low stability of hydroxide ions in slightly and moderately alkaline aqueous media, as well as due to the interaction with active internal surfaces and impurities. This situation leads to the need to implement a special regime for monitoring and regulating the electrolysis process.

Therefore, the electrolyzer is provided with a control system, which is equipped with sensors for water input and flow, current strength and, of course, a pH measuring device. Based on the readings of the process sensors and the set of pH values, the consistent process parameters are determined.

Such characteristics, first of all, are the current strength of the electrolysis process and the amount of water supply flow (water flow) at the entrance to the electrolyzer, as well as the purity of the water at the entrance to the electrolyzer. The characteristics are consistent, because changing one leads to changing the other.

For example, an increase in the pH value of the catholyte can be achieved both by reducing water consumption and by increasing the current of the process or by compensatory changes in both characteristics. Similarly, with regard to the purity of water supplied for electrolysis-increasing purity leads to the possibility of reducing the current strength.

It should be clarified once again that water approaches the electrolyzer along one line,—along the input line. However, when entering the electrolyzer, this main flow is divided into two: one is sent to the cathode space, and the other to the anode. In this case, the flow of incoming water can be regulated both on the common supply line to the electrolyzer and on the branch lines into the cathode and/or anode space.

Regulation of the electrolysis process current and water flow (flow) is carried out on appropriate devices. To regulate the current, in particular, rheostats or thyristor regulators are used; to regulate water flow, for example, ball or needle valves with a mechanical drive, and electromagnetic valves are used.

Parts of the electrolyzer, including the body and electrodes, are made mainly of stainless materials; the materials of the partitions between the electrode spaces are fine-pored ceramics.

The anolyte is removed from the anode space of the electrolyzer through a separate line and sent directly to the mixing or to storage tank. The catholyte is removed from the cathode space through a separate line and directed to mixing or to a storage tank. Products from storage tanks can also be mixed to obtain water with a predetermined pH or sent to the consumer.

The anolyte from the storage tank, in particular, can be used for washing or disinfecting individual devices of the cleaning system. The catholyte is dispensed from the storage tank into bottling at a specially equipped dispensing point or into the containers with an internal decontaminated surface.

In some cases, flakes of metal hydroxides may precipitate in the cathode space of the electrolyzer. For this reason, another ultrafiltration device is installed at the line where the catholyte leaves the electrolyzer, and before the catholyte storage tank or mixing device.

The catholyte and anolyte removal equipment is made of stainless steel or polymer materials with decontaminated internal surfaces.

The catholyte dispensing device solves the problem of maintaining a predetermined pH value during dispensing due to the rapid organization of dispensing and the use of materials deactivated with respect to hydroxide ions.

Typically, stainless steel is used as the material for tubes and pipes of the dispensing device, as well as dispensing containers. Dispensing time is reduced by shortening the dispensing path and electrolysis time.

The present invention takes into account the data on enhancing the oxidizing capacity of ozone in an alkaline medium, presented earlier in the review of the prior art. According to the present invention, an alkaline environment in the inlet compartment of the ultrafiltration device is created by introducing into this compartment the catholyte obtained in the electrolyzer as a product for the intended purpose.

For this purpose, in the inventive method, an additional separate pipeline line is made, connecting the outlet from the cathode space of the electrolyzer or from the catholyte storage tank with the technological elements of water preliminary treatment devices. These technological elements can be a contact tank, an entrance to a contact tank, or a recycling line.

Thus, the catholyte also has a secondary technological function, and an additional separate pipeline line ensures the implementation of this function, which makes it possible to increase the degree of water purification from organic impurities at the ultrafiltration stage.

The specified separate pipeline line may have shut-off and control valves at both ends, and on the side of connection to the technological elements of preliminary water treatment it has an inlet device.

This inlet device can be designed as an ejector, a pipe or an injector. The catholyte is supplied to the elements of the technological scheme of the water purification process until a certain pH value in the filtered water is reached in the range from 8.0 to 11.0. This value is determined based on the degree of water contamination with organic impurities and is maintained constant, at least in the first membrane filtration device.

Parallel to the above-mentioned purification process line, there is an auxiliary process line-a bypass, which is connected to the main process line in the process units between the purification stages, before the electrolyzer and, if necessary, behind the electrolyzer.

If necessary, depending on the composition of the source water, the described purification line can be supplemented with deozonation devices, a pump, measuring and control devices and sensors, and hydraulic accumulators. If additional ozone removal is necessary, carbon adsorbents are used.

The housings of the cleaning unit devices and pipelines, as well as additional devices, are mainly made of stainless steel, polymer and metal-polymer materials.

Distinctive from the prior art, essential features of the present invention or their characteristics are:
membrane filtration is carried out on at least one membrane filtration device,
supplying the purified water to the inlet compartment of at least the first membrane filtration device is by using a water-jet ejector, through which an ozone-air or ozone-oxygen mixture is simultaneously supplied to ozonate this water,
supply of catholyte to the technological scheme of the water preliminary preparation process until the pH value (pH) in the filtered water of the first membrane filtration device is reached in the range from 8.0 to 11.0.

The predetermined essential features are distinctive from the prior art, because each of them is not contained in the totality of essential features of the prototype, i.e. is not present in the list of features implemented in the prior art and is not their characteristic.

As has already been shown above, the indicated essential features distinguishing from the prototype, including their characteristics, ensure the achievement of the declared technical result when using other essential features of the invention specified in the description.

Thus, it is shown that the set of essential features of the present invention, which makes it possible to achieve the required technical result, differs from the set of essential features of analogues, a prior art, as well as other known sources of data, i.e. the use of this set of essential features to obtain the stated technical result is not known. In other words, the present invention is not known from the prior art.

In the course of studying the state of the art of methods for producing water with predetermined properties, no technical solutions were identified whose essential features, individually or in any combination, coincide with the distinctive essential features of the present invention and make it possible to achieve the present technical result. Thus, the lack of knowledge of the influence of the distinctive essential features of the present invention on the present technical result has been confirmed.

It should also be noted that the use of the entire declared set of essential features, including the set of distinctive features, to obtain the declared technical result is not obvious to specialists from the prior art, since it does not constitute a combination, modification or sharing of the information contained in the level of technology, and/or general knowledge of a specialist.

Indeed, the production of water of a predetermined degree of purification and with a predetermined pH value during the oxidation of organic impurities in an alkaline medium in the inlet compartment of the first ultrafiltration device due to oxidation with an ozone mixture when it is supplied simultaneously with water through the ejector when feeding catholyte from the electrolyzer of the technological scheme for obtaining water into the process devices Schemes for preliminary water preparation do not follow explicitly from the prior art for specialists due to the use of the above-mentioned distinctive essential features.

The technical solutions presented are, in relation to the confirmed achievement of the stated technical result, non-standard and unknown solutions. In addition, these solutions or these sets of essential features should be considered along with the use of other essential features claimed in the claims in a single set.

An increase in the efficiency of the stated technical result is achieved in the following special case of its implementation:

The method described above for producing water with specified properties, characterized in that an additional ultrafiltration process is carried out at the line where the catholyte leaves the electrolyzer.

The method described above for producing water with specified properties involves the implementation of a device, the design elements of which were described above when describing this method, namely:

A device for producing water with specified properties, consisting of a set of water pre-treatment devices, membrane filtration devices, an electrolyzer for producing anolyte and catholyte and devices for mixing them.

The apparatus of the invention comprises at least one membrane filtration device, at least the first membrane filtration device is provided at the inlet with at least one water-jet ejector for supplying an ozone-air or ozone-oxygen mixture to the filtered water, and a separate supply line is provided from the catholyte output line from the electrolyzer catholyte into one of the water preliminary preparation devices for ultrafiltration of an alkaline environment with a pH in the range from 8.0 to 11.0. The technical result of this device is similar to that specified for the method described above.

An increase in the efficiency of the technical result for the described device is achieved in the following special case of its implementation: the above-described device for producing water with specified properties, characterized in that an additional ultrafiltration device is installed on the line where the catholyte leaves the electrolyzer.

### BRIEF DESCRIPTION OF THE DRAWING

The description of the present method and device is illustrated by the drawing showing the following designations of its processes:

FIG. 1 is a diagram illustrating the method and apparatus of the invention, wherein

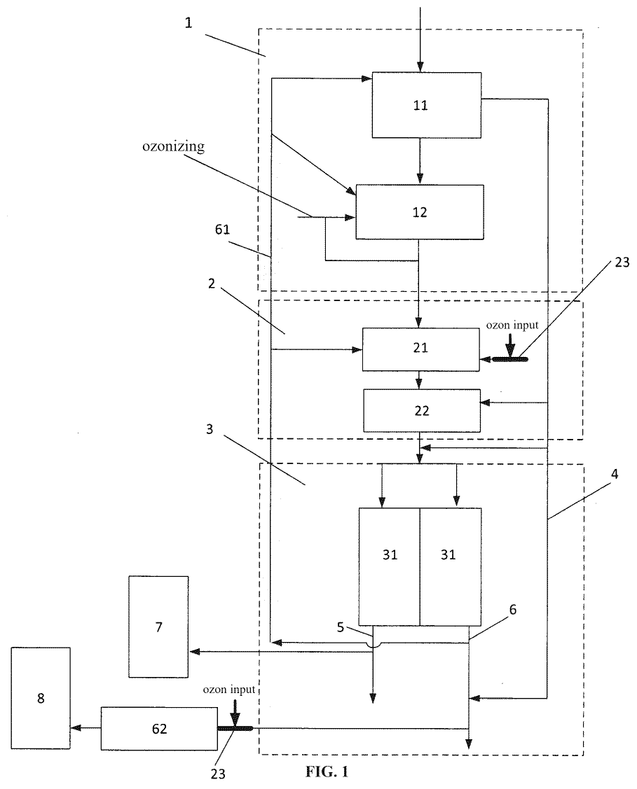

1—preliminary water preparation,
11—pre/initial cleaning device,
12—disinfection device,
2—membrane filtration,
21—ultrafiltration devices,
22—reverse osmosis filters,
23—water-jet ejector (indicate the ozone input with an arrow on the side),
3—electrolytic treatment,
31—electrolyzer,
4—regulation of the degree of water purification using a bypass line,
5—anolyte removal line,
6—catholyte removal line,
61—separate line for supplying catholyte to one of the water pre-treatment devices,
62—additional ultrafiltration device,
7—anolyte storage tank,
8—catholyte storage tank.

### DESCRIPTION OF THE EMBODIMENTS OF THE INVENTION

The present invention entitled “METHOD FOR PRODUCING WATER WITH PREDETERMINED PROPERTIES AND DEVICE FOR IMPLEMENTATION SAME” is carried out in the following manner.

Producing water with desired properties requires careful initial purification of the water. To do this initially a step of preliminary water preparation 1 is carried out, which may include the processes/steps of the preliminary mechanical purification 11 and disinfection 12.

The water prepared in this way is directed to membrane filtration 2, which can be carried out using two types of devices: ultrafiltration devices 21 and reverse osmosis filters 22. The number of ultrafiltration devices can vary from one to several, for example, up to three devices can be provided.

In this case, water is supplied to at least the first device by means of at least one water-jet ejector 23 with the simultaneous supply of ozone-air or ozone-oxygen mixture. Similarly, the number of reverse osmosis filters can also vary from one to several, for example up to three filters can be provided.

After the membrane filtration step, the water is sent to the electrolysis 3, where the water is decomposed into anolyte and catholyte, which are removed from the electrolyte cell 31, along the lines of anolyte 5 and catholyte 6 respectively. To implement an alkaline environment in the ultrafiltration devices, a separate catholyte supply line 61 is arranged. For this purpose, line 61 is diverted from the catholyte discharge line to one of the water pre-treatment devices.

The anolyte and catholyte are preferably directed and accumulated in storage tanks 7 and 8, respectively. An additional ultrafiltration device is also preferably installed on the catholyte removal line. Regulation of flows between devices is carried out using bypass line 4. All devices implementing the technological scheme are connected to the line 4.

The described method and device operate in the following manner.

Initially, an analysis of the water intended for treatment is carried out. After that, the need for mechanical cleaning measures, the number of ultrafiltration devices, the number of reverse osmosis filters, the composition of the ozone mixture, and the need to have or use an additional ultrafiltration device are determined.

The specified technological scheme is determined based on the targeted specified properties of water. Source water, according to a certain technological scheme, is initially sent to a device for separation from mechanical impurities, for example, sent to a mechanical filter.

The resulting water is disinfected by bubbling the ozone mixture through a layer of water in a contact container simultaneously with the recycling according to the output-input scheme.

Disinfected water is sent to the ultrafiltration device through a water-jet ejector, which is installed at the inlet to this device. At the same time, an ozone-air or ozone-oxygen mixture is fed through the ejector.

Filtration is carried out at the membranes with a pore size of 0.01-0.1 microns at a differential pressure of 0.05-0.6 MPa, a flow rate of the ozone-air mixture through the ejector 8×10⁵-56×10⁵ m³/s (0.3-2 m³/hour), and the content of dissolved ozone in the mixture is 0.01-1 g/m³. After the ultrafiltration device, the water is purified using a reverse osmosis filter with a pore size of 10⁴-10³ microns, at a differential pressure of 0.4-2.0 MPa (it is possible to use several ultrafiltration devices and the reverse osmosis filters). The water purified by the method described above is sent to an electrolyzer to carry out its electrolysis.

At the exit from electrolysis, a catholyte with pH values=8-11 and an analyte with pH values=3-6 are obtained. The catholyte and anolyte are collected in the storage containers. Water with specified pH values is obtained by mixing calculated amounts of anolyte and catholyte.

Mixing is carried out in mixing lines or containers. To increase the efficiency of the purification process, the oxidation of organic and organochlorine impurities is carried out in the alkaline environment with a pH value in the range between 8.0 and 11.0.

To do this, the catholyte is taken from the line of its output from the electrolyzer through a separate special line to the technological devices for preliminary water purification. This step provides an alkaline environment in the contact tank and ultrafiltration device(s).

If the water is significantly contaminated with metal ions, the catholyte may be contaminated with metal hydroxides in the form of flakes. In this case, an ultrafiltration device is additionally installed at the catholyte outlet from the electrolyzer. Regulation of flows between the devices is carried out using a bypass line, to which all devices implementing the technological scheme are connected.

### Example 1

The task is to obtain purified water with the following characteristics: pH from 7.2 to 7.5, iron content 0.05-0.07 mg/dm³, manganese content 0.06-0.07 mg/dm³, permanganate oxidation 0.5-3 Og/dm³.

At the entrance to the system for producing water with specified properties, the water had the following characteristics: pH=6.8, iron content was 1.5 mg/dm³, manganese content was 0.3 mg/dm³, permanganate oxidation was 6 mg Og/dm³, content mechanical impurities-10 mg/dm³, presence of traces of chlorine and organochlorine compounds.

The specified water was subjected to mechanical purification and ozonation in a closed container by treating with ozone using the bubbling method with simultaneous mixing of the mixture by recirculation.

Then the water was sent to the ultrafiltration device through a water-jet ejector simultaneously with the supply of the ozone-air mixture. In this case, the filtration conditions were as follows: pH of the filtered medium=6.8; differential pressure 0.05 MPa; flow rate of the ozone-air mixture through the ejector 28×10-5 m³/s (1 m³/hour), dissolved ozone content in the mixture 0.01-1 g/m³.

After the ultrafiltration device, the water was sent to a reverse osmosis filter, where filtration was carried out at a differential pressure of 1.5 MPa and a water flow rate of 1.5 m³/hour.

After the reverse osmosis filter, the water had the following characteristics-pH=6.5; iron content 0.05 mg/dm³; manganese—0.07 mg/dm³; permanganate oxidation from 0.5 to 3 mg Og/dm³, absence of mechanical impurities, chlorine, organic and organochlorine compounds.

This water enters the inlet of an electrolyzer with a working volume of 30 liters. In the electrolyzer water was subjected to electrolytic treatment at the current of 7 amp and a water supply volume of 0.3-1 m³/hour.

As a result of this treatment, at the outlet of the electrolyzer the anolyte had a pH value=4.5 and the catholyte pH=8.5. By mixing these products in the calculated ratio, water with pH values from 7.2 to 7.5 was obtained.

To maintain constant cleaning and electrolysis parameters, the inlet compartment of the ultrafiltration device and its membranes are cleaned once every 3 weeks.

### Example 2

The implementation of the present method was carried out similarly to Example 1. However, the pH of the filtered medium in the ultrafiltration device was 8.5. To establish such a pH value of the filtered medium, a separate line of catholyte supply to the contact vessel was provided from the catholyte outlet line from the electrolyzer.

The entrance to the contact container was made through a separate pipe under the water input device. Thus, the oxidation of organic and organochlorine impurities was carried out in an alkaline environment.

To maintain constant cleaning and electrolysis parameters, the inlet compartment of the ultrafiltration device and its membranes are cleaned once every 3 months.

### Example 3

The implementation of the proposed method and device was carried out similarly to Example 2. However, the source water had the following characteristics: pH=6.6; iron content was 10.5 mg/dm³; manganese content was 3 mg/dm³; permanganate oxidation was 16 mg O2/dm³; content of mechanical impurities—30 mg/dm³, presence of traces of chlorine and organochlorine compounds.

The number of ultrafiltration devices was 2, and the filtration conditions in these devices were as follows: pH of the filtered medium=8.5; differential pressure 0.6 MPa; flow rate of the ozone-air mixture through the ejector 42×10⁵ m³/s (1.5 m³/hour), the content of dissolved ozone in the mixture was 0.01 g/m³.

The number of reverse osmosis filters was also 3 at a differential pressure of 2.0 MPa and a water flow of 0.6 m³/hour. Electrolysis was carried out at a current of 15 A?? and a water supply volume of 0.3-1 m³/hour. As a result of this treatment, at the outlet of the electrolyzer the anolyte had a pH value=4.3, and the catholyte pH=8.5.

By mixing these products in the calculated ratio, water with pH values from 7.2 to 7.5 was obtained.

To maintain constant cleaning and electrolysis parameters, the inlet compartment of the ultrafiltration device and its membranes are cleaned once every 2 months.

### Example 4

The implementation of the proposed method and device was carried out similarly to Example 3. But the source water had the following characteristics: pH—7; iron content was 15 mg/dm³; manganese content was 4 mg/dm³; permanganate oxidation was 18 mg Og/dm³; mechanical content impurities—25 mg/dm³; presence of traces of chlorine and organochlorine compounds.

The number of ultrafiltration devices was 2; the number of ejectors for introducing water and ozone mixture into the first ultrafiltration device was 6; into the second device-1. The filtration conditions on these devices were as follows: pH of the filtered medium=9; differential pressure 0.15 MPa; flow rate ozone-air mixture through an ejector 56×10⁵ m³/s (2 m³/hour), the content of dissolved ozone in the mixture is 1.0 g/m³.

The number of reverse osmosis filters was also 2 at a differential pressure of 2 MPa and a water flow of 0.4 m³/hour. Electrolysis was carried out at a current of 12 A and a water supply volume of 0.3-0.6 m³/hour.

As a result of this treatment, at the outlet of the electrolyzer the anolyte had a pH value=4.6; and the catholyte pH=9. By mixing these products in the calculated ratio, water with pH values from 7.2 to 7.5 was obtained.

To maintain constant cleaning and electrolysis parameters, the inlet compartment of the ultrafiltration device and its membranes are cleaned once every 3 months.

The above examples should not be construed as limiting the scope of the invention. On the contrary, variations, modifications and equivalents of the examples described are also possible within the scope of the rights set forth in the claims.

It was discussed above that the method of the invention consists of the steps of performing pretreatment of water, membrane filtration, producing a catholyte and an anolyte in an electrolyzer, and mixing said catholyte and anolyte. The membrane filtration is performed on at least one membrane filtration apparatus. The purified water is supplied to the inlet compartment of at least the first membrane filtration apparatus using at least one water jet ejector, wherein an ozone-air or ozone-oxygen mixture is simultaneously supplied through said ejector to ozonise the water. At the same time, the catholyte is added to the process circuit of the water pretreatment process until the pH value in the range from 8.0 to 11.0 is reached in the filtered water at the stage of pretreatment and on at least the first membrane filtration apparatus.

### INDUSTRIAL APPLICABILITY OF THE INVENTION AND ACHIEVEMENT OF THE TECHNICAL RESULT

The present invention is a technical solution, because represents a solution to the problem of achieving the stated technical result by implementing a method that consists in carrying out actions on material objects using material means.

In this case, the material objects are water, ozone, catholyte, and anolyte. These material objects are subject to the actions of supply (for water, catholyte, anolyte), treatment with oxidizing agents (for water), purification by filtration, electrolytic treatment, flow separation, supply and flow control.

All actions on the said material objects are performed on time and in a certain sequence. At the same time, the totality of these actions—the essential features of this invention are technologically and functionally interconnected and united by a single creative concept.

This technical solution is industrially applicable in the field of producing water with specified properties. It can be used in medicine in the field of gastroenterology, to ensure certain disinfection processes, in chemistry to achieve certain pH values and other areas.

This technical solution can be implemented by specialists with appropriate training. When implementing the present invention, devices, instruments and materials are used that are produced by industry and are publicly available.

Methods for carrying out the technological scheme of the invention include methods of machining metal and plastics, electric welding and heat welding of plastics, locksmithing, and assembly.

Methods for implementing the technological scheme of the invention are methods of mechanical processing of metal and plastics, electric welding and thermal welding of plastics, metalworking, installation.

The above set of essential features of the present invention and their disclosure allows us to conclude that the present technical result has been achieved, namely, an increase in the degree of water purification from organic impurities at the filtration stage in at least the first membrane filtration device, due to better mixing of the ozone mixture with water, as well as due to better oxidation of organic impurities by ozone in an alkaline environment with the coordinated implementation of these processes.

In turn, the implementation of the purpose of the invention is confirmed by the production of water with a predetermined pH value through the use of an electrolyzer with comprehensive control of the parameters of the water electrolysis process and coordinated regulation of water supply and current strength, as well as when mixing anolyte and catholyte.

1. A method for producing water having predetermined properties, comprising the following steps:
preliminary water preparation, membrane filtration, production of catholyte and anolyte, and mixing thereof in a required ratio,
wherein the step of membrane filtration is carried out in at least one membrane filtration device,
wherein supply of a purified water to an inlet compartment of at least a first membrane filtration device is carried out using a water-jet ejector, an ozone-air or an ozone-oxygen mixture is simultaneously supplied to ozonate said water by using said water-jet ejector; and
wherein simultaneously with the step of supplying the purified water the catholyte is supplied to the step of the water preliminary preparation until pH value in the filtered water of the first membrane filtration device is in the range between 8.0 and 11.0.

2. The method according to claim 1, wherein an additional ultrafiltration process is carried out in a catholyte exit pipeline from an electrolyzer.

3. A device for producing water having predetermined properties, comprising:
a combination of water pretreatment devices including membrane filtration devices, an electrolyzer for producing anolyte and catholyte and devices for mixing thereof,
wherein said device for producing water further comprises membrane filtration devices, so that at least a first membrane filtration device is provided at an inlet with at least one water-jet ejector for supplying a filtered water with an ozone-air or ozone-oxygen mixture, and
wherein at an outlet line for the catholyte exiting from the electrolyzer there is provided a separate line of catholyte supply to one of the devices of said water pretreatment combination for producing in the devices for ultrafiltration an alkaline medium with pH in the range between 8.0 and 11.0.

4. The apparatus according to claim 3, wherein an additional ultrafiltration device is provided at the catholyte outlet line exiting from the electrolyzer.
